(19) United States
(12) Patent Application Publication
(10) Pub. No.: US 2025/0159459 A1
(43) Pub. Date: May 15, 2025

(54) COMMUNICATION PROCESSING METHOD AND APPARATUS, COMMUNICATION DEVICE, AND READABLE STORAGE MEDIUM

(71) Applicant: VIVO MOBILE COMMUNICATION CO., LTD., Dongguan (CN)

(72) Inventors: Sihan CHENG, Dongguan (CN); Xiaobo WU, Dongguan (CN); Weiwei CHONG, Dongguan (CN)

(73) Assignee: VIVO MOBILE COMMUNICATION CO., LTD., Dongguan (CN)

(21) Appl. No.: 19/021,014

(22) Filed: Jan. 14, 2025

Related U.S. Application Data
(63) Continuation of application No. PCT/CN2023/106312, filed on Jul. 7, 2023.

(30) Foreign Application Priority Data
Jul. 14, 2022 (CN) 202210832602.8
Oct. 9, 2022 (CN) 202211228214.5

(51) Int. Cl. H04W 8/14

(52) U.S. Cl. CPC H04W 8/14

(57) ABSTRACT

This application provides a communication processing method and apparatus, a communication device, and a readable storage medium. The communication processing method includes: receiving, by a terminal, a first parameter from a first core network device; and establishing, by the terminal, the first service based on the first parameter. The first parameter includes a parameter supported by a first service of a roaming location network serving the terminal

### CROSS-REFERENCE TO RELATED APPLICATIONS

This application is a continuation of International Application No. PCT/CN 2023/106312, filed on Jul. 7, 2023, which claims priority to Chinese Patent Application No. 202210832602.8, filed on Jul. 14, 2022, and Chinese Patent Application No. 202211228214.5, filed on Oct. 9, 2022. The entire contents of each of the above-referenced applications are expressly incorporated herein by reference.

### TECHNICAL FIELD

This application pertains to the field of communication technologies, and specifically, to a communication processing method and apparatus, a communication device, and a readable storage medium.

### BACKGROUND

Different operators support different voice capabilities. For example, the Guaranteed Bit Rate (GBR) or Maximum Bit Rate (MBR) supported by operators A, B, and C for voice are 64 kbps, 156 kbps, and 512 kbps, respectively:
Mobile Network Operator (MNO) A uses a GBR value of 64 kbps;
MNO B uses a GBR value of 156 kbps; and
MNO C uses a GBR value of 512 kbps.

For example, when a terminal of MNO C (such as a User Equipment (UE)) roams to MNO A, the terminal initiates an Internet protocol (IP) Multimedia Subsystem (IMS) session request and establishes a voice bearer with a GBR of 512 kbps based on the stored configuration of MNO C. In some embodiments, the Session Initiation Protocol (SIP) invite message carries Session Description Protocol (SDP) information, where the SDP information contains the information on using the GBR parameter of 512 kbps.

When MNO A establishes the voice bearer according to the IMS layer negotiation results, since MNO A only supports a voice bearer establishment of 64 kbps, the network side will reject the voice bearer establishment request, leading to the failure of voice bearer establishment and causing the user to be unable to use voice services while roaming.

### SUMMARY

Embodiments of this application provide a communication processing method and apparatus, a communication device, and a readable storage medium.

According to a first aspect, a communication processing method is provided, including:
receiving, by a terminal, a first parameter from a first core network device, where the first parameter includes a parameter supported by a first service of a roaming location network serving the terminal; and
establishing, by the terminal, the first service based on the first parameter.

According to a second aspect, a communication processing method is provided, including:
obtaining, by a first core network device, a first parameter, where the first parameter includes a parameter supported by a first service of a roaming location network serving the terminal; and
sending, by the first core network device, the first parameter to the terminal, where the first parameter is used for establishing the first service for the terminal;
and/or
sending, by the first core network device, the first parameter to a second core network device, where the first parameter is used for the second core network device to process a fourth message, and the fourth message is for establishing the first service for the terminal.

According to a third aspect, a communication processing method is provided, including:
receiving, by a second core network device, a first parameter sent by a first core network device, where the first parameter includes a parameter supported by the first service of a roaming location network serving the terminal; and
processing, by the second core network device, a fourth message based on the first parameter, where the fourth message is used for establishing the first service for the terminal.

According to a fourth aspect, a communication processing apparatus is provided, including:
a first receiving module, configured to receive a first parameter from a first core network device, where the first parameter includes a parameter supported by a first service of a roaming location network serving the terminal; and
an establishing module, configured for the terminal to establish the first service based on the first parameter.

According to a fifth aspect, a communication processing apparatus is provided, including:
a first obtaining module, configured to obtain a first parameter, where the first parameter includes a parameter supported by a first service of a roaming location network serving the terminal; and
a second sending module, configured to send the first parameter to the terminal, where the first parameter is used for establishing the first service for the terminal; and/or send the first parameter to a second core network device, where the first parameter is used for the second core network device to process a fourth message, and the fourth message is used for establishing the first service for the terminal.

According to a sixth aspect, a communication processing apparatus is provided, including:
a second receiving module, configured to receive a first parameter sent by a first core network device, where the first parameter includes a parameter supported by the first service of a roaming location network serving the terminal; and
a processing module, configured to process a fourth message based on the first parameter, where the fourth message is used for establishing the first service for the terminal.

According to a seventh aspect, a communication device is provided, including a processor, a memory, and a program or instruction stored in the memory and capable of running on the processor, and when the program or instruction is executed by the processor, the steps of the method according to the first, second, or third aspect are implemented.

According to an eighth aspect, a readable storage medium is provided, where the readable storage medium stores a program or instruction, and when the program or instruction is executed by a processor, the steps of the method according to the first, second, or third aspect are implemented.

According to a ninth aspect, a chip is provided, where the chip includes a processor and a communication interface, the communication interface is coupled to the processor, and the processor is configured to run a program or instruction to implement the steps of the method according to the first, second, or third aspect.

According to a tenth aspect, a computer program/program product is provided, where the computer program/program product is stored in a non-transient storage medium, and the computer program/program product is executed by at least one processor so as to implement the steps of the method according to the first, second, or third aspect.

According to an eleventh aspect, a communication system is provided, the communication system including at least two of a terminal, a first core network device, and a second core network device, where the terminal is configured to perform the steps of the method as described in the first aspect, the first core network device is configured to perform the steps of the method as described in the second aspect, and the second core network device is configured to perform the steps of the method according to the third aspect.

In the embodiments of this application, since the terminal can obtain the parameter supported by the first service of the roaming location network and establish the first service based on the parameter supported by the first service of the roaming location network, the terminal and the communication counterpart can successfully establish the first service, thereby enhancing the user experience.

### BRIEF DESCRIPTION OF DRAWINGS

FIG. 1 is a flowchart of establishing a voice bearer between UE-1 and UE-2;

FIG. 2 is a schematic architectural diagram of a wireless communication system according to an embodiment of this application;

FIG. 3 is a first flowchart of a communication processing method according to an embodiment of this application;

FIG. 4 is a second flowchart of a communication processing method according to an embodiment of this application;

FIG. 5 is a third flowchart of a communication processing method according to an embodiment of this application;

FIG. 6 is a schematic diagram of a registration process according to embodiment 1 of this application;

FIG. 7 is a schematic diagram of obtaining PLMN information of UE-1 according to embodiment 1 of this application;

FIG. 8 is a schematic diagram of a registration process according to embodiment 2 of this application;

FIG. 9 is a schematic diagram of a call process according to embodiment 3 of this application;

FIG. 10 is a schematic diagram of a call process according to embodiment 4 of this application;

FIG. 11 is a schematic diagram of a call process according to embodiment 5 of this application;

FIG. 12 is a schematic diagram of a call process according to embodiment 6 of this application;

FIG. 13 is a schematic diagram of a call process according to embodiment 7 of this application;

FIG. 14 is a first schematic diagram of a communication processing apparatus according to an embodiment of this application;

FIG. 15 is a second schematic diagram of a communication processing apparatus according to an embodiment of this application;

FIG. 16 is a third schematic diagram of a communication processing apparatus according to an embodiment of this application;

FIG. 17 is a schematic diagram of a terminal according to an embodiment of this application;

FIG. 18 is a schematic diagram of a core network device according to an embodiment of this application; and

FIG. 19 is a schematic diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship. The term “indication” in the specification and claims of this application can be either an explicit indication or an implicit indication. An explicit indication can be understood as the sender explicitly informing the receiver of the operation to be performed or the requested result in the indication sent. An implicit indication can be understood as the receiver making a judgment based on the indication sent by the sender and determining the operation to be performed or the requested result based on the judgment.

It should be noted that technologies described in the embodiments of this application are not limited to Long Term Evolution (LTE) or LTE-Advanced (LTE-A) systems, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6^{th} Generation (6G) communication system.

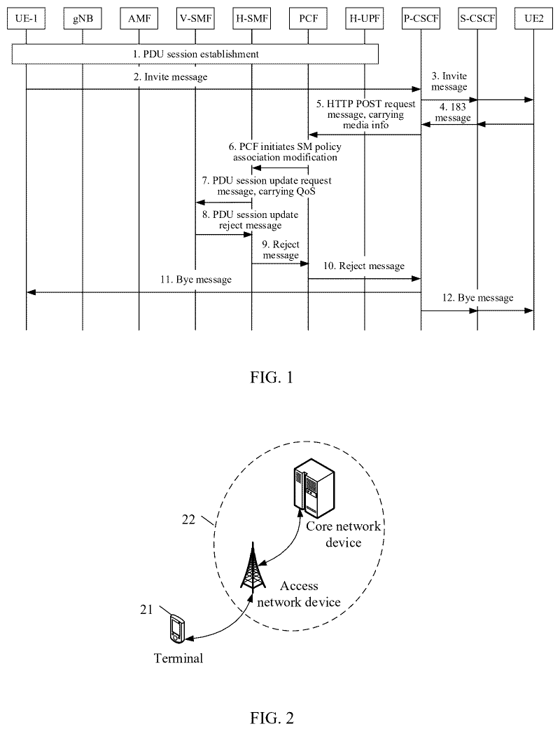

Referring to FIG. 1, where the figure illustrates a process of establishing a voice bearer between UE-1 and UE-2. The specific steps are as follows:

Step 1: UE-1 establishes a Protocol Data Unit (PDU) session in a roaming location network (for example, MNO A), using a Visiting Session Management Function (V-SMF).

Step 2: UE-1 initiates an IMS establishment request via an invite (Invite) message, where the information of the voice media to be established is carried in the SDP of the request, requesting to establish a voice bearer with a GBR of 512 kbps via b=Application Server (AS):512.

Step 3: A Proxy-Call Session Control Function (P-CSCF) sends the invite message to UE-2 through a Serving Call Session Control Function (S-CSCF).

It should be noted that the P-CSCF and S-CSCF in the figure are both IMS network elements serving UE-1, and the IMS network elements serving UE-2 are not shown.

Step 4: UE-2 replies with an SIP 183 message through the S-CSCF, where the message contains an SDP answer.

Step 5: The P-CSCF sends a HyperText Transfer Protocol (HTTP) post request message to a Policy Control Function (PCF) serving UE-1, where the message carries the media info negotiated through the SDP, and the media info is obtained from the SDP answer message and contains information indicating the need to use 512 kbps.

Step 6: The PCF sends a request to a Home-Session Management Function (H-SMF) of UE-1, requesting to establish a voice bearer. The request carries the Quality of Service (QoS) parameters of the voice bearer to be established, where the parameters contain the information of GBR as 512 kbps.

Step 7: The H-SMF sends a PDU session update request message (for example, an Nsmf_PDUSession_Update Request message) to a V-SMF, where the message may include QoS parameters.

Step 8: The V-SMF determines that it cannot support the GBR bearer of 512 kbps based on the QoS parameters of the request and the QoS parameters it can support, and then the V-SMF sends a PDU session update reject message (for example, an Nsmf_PDUSession_Reject message) to the H-SMF.

Step 9: The H-SMF sends a PDU session update reject message to the PCF, that is, an H-SMF initiated SM policy association reject.

Step 10: The PCF sends a PDU session update reject message to the P-CSCF.

Step 11: The P-CSCF sends a bye message to UE-1 to reject the call.

Step 12: The P-CSCF sends a Bye message to UE-2 to terminate the call.

In other words, when UE-1 is in a roaming state, the inconsistency between the parameters of the home network and the roaming location network causes UE-1 to be unable to make or receive voice calls, affecting user experience.

FIG. 2 is a block diagram of a wireless communication system to which embodiments of this application are applicable. The wireless communication system includes a terminal 21 and a network-side device 22.

The terminal 21 may be a mobile phone, tablet personal computer, laptop computer or notebook computer, Personal Digital Assistant (PDA), palmtop computer, netbook, Ultra-Mobile Personal Computer (UMPC), mobile internet device (Mobile Internet Device, MID), Augmented Reality (AR)/Virtual Reality (VR) device, robot, Wearable Device (WD), Vehicle User Equipment (VUE), Pedestrian User Equipment (PUE), smart home device (wireless communication-enabled home devices such as refrigerators, televisions, washing machines, or furniture), gaming console, Personal Computer (PC), automated teller machine or self-service machine, or other terminal-side device. Wearable devices include smartwatches, smart bands, smart earphones, smart glasses, smart jewelry (smart bangles, smart bracelets, smart rings, smart necklaces, smart foot bangles, and smart anklets), smart wristbands, and smart clothing. In addition to the foregoing terminal device, the terminal involved in this application may also be a chip within the terminal, such as a modem chip or a System on Chip (SoC). It should be noted that the specific type of the terminal 21 is not limited in the embodiments of this application.

The network-side device 22 can include an access network device or core network device, where the access network device can also be referred to as a radio access network device, Radio Access Network (RAN), radio access network function, or radio access network unit. The access network device may include base stations, Wireless Local Area Network (WLAN) access points, WiFi nodes, or the like. The base station may be referred to as Node B, Evolved Node B (eNB), access point, Base Transceiver Station (BTS), radio base station, radio transceiver, Basic Service Set (BSS), Extended Service Set (ESS), home Node B, home evolved Node B, Transmitting Receiving Point (TRP), or other appropriate terms in the field. As long as the same technical effect is achieved, the base station is not limited to any specific technical terminology. It should be noted that in the embodiments of this application, only the base station in the NR system is introduced as an example, and the specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), a Unified Data Management (UDM), a Unified Data Repository (UDR), a Home Subscriber Server (HSS), Centralized network configuration (CNC), a Network Repository Function (NRF), a Network Exposure Function (NEF), a local NEF (L-NEF), a Binding Support Function (BSF), an Application Function (AF), and the like. It should be noted that only a core network device in an NR system is used as an example in the embodiments of this application and the core network device is not limited to a specific type.

The following describes in detail the communication processing method and apparatus, communication device, and readable storage medium provided in the embodiments of this application through some embodiments and application scenarios thereof with reference to the accompanying drawings.

Referring to FIG. 3, an embodiment of this application provides a communication processing method applied to a terminal. Specific steps include: step 301 and step 302.

Step 301: The terminal receives a first parameter from a first core network device, where the first parameter includes a parameter supported by a first service of a roaming location network serving the terminal.

In this embodiment of this application, the first core network device is configured to, in a case of determining that the terminal is in a roaming state, obtain a parameter supported by the first service corresponding to the Visited Public Land Mobile Network (VPLMN) serving the terminal, and send that parameter to the terminal, enabling the terminal to use this parameter to establish the first service.

For example, the first core network device may include, but is not limited to, an S-CSCF, and the first service may include, but is not limited to, voice service, video service, or the like.

For example, the parameter may include, but is not limited to, at least one of GBR and MBR.

Step 302: The terminal establishes the first service based on the first parameter.

For example, the terminal may determine the Session Description Protocol (SDP) information that the terminal can use based on the first parameter and establish the first service based on the SDP information.

For example, establishing the first service may be understood as establishing a connection corresponding to the first service, or establishing a call corresponding to the first service, or establishing a call connection corresponding to the first service. For example, taking the first service being a voice service as an example, establishing the first service may be understood as establishing the voice service, establishing a connection corresponding to the voice service, establishing a call corresponding to the voice service, or establishing a call connection corresponding to the voice service.

In one embodiment of this application, the method further includes:
sending, by the terminal, a register (registration) request message to the first core network device, where the register request message carries an identifier of the roaming location network serving the terminal. In other words, during terminal registration, the first core network device can determine whether the terminal is in a roaming state based on the identifier of the roaming location network obtained during the registration process.

In one embodiment of this application, that the terminal receives a first parameter from the first core network device may include:
the terminal receives a register accept message from the first core network device, where the register accept message may carry the first parameter.

In one embodiment of this application, that the terminal establishes the first service based on the first parameter may include:
the terminal sends a first message, where the first message is used for requesting to establish the first service for the terminal, and the first message may carry the first parameter;

For example, the first message may be a call request message. In another embodiment of this application, that the terminal establishes the first service based on the first parameter includes:
the terminal sends a second message, where the second message is used for responding to a third message, the third message is used for requesting to establish the first service for the terminal, and the second message may carry the first parameter.

For example, the second message may be a response message to the call request message.

In this embodiment of this application, the terminal receives the first parameter from the first core network device, where the first parameter includes a parameter supported by the first service of the roaming location network serving the terminal. The terminal establishes the first service based on the first parameter. Since the terminal can obtain the parameter supported by the first service of the roaming location network and establish the first service based on the parameter supported by the first service of the roaming location network, the terminal and the communication counterpart can successfully establish the first service, thereby enhancing the user experience.

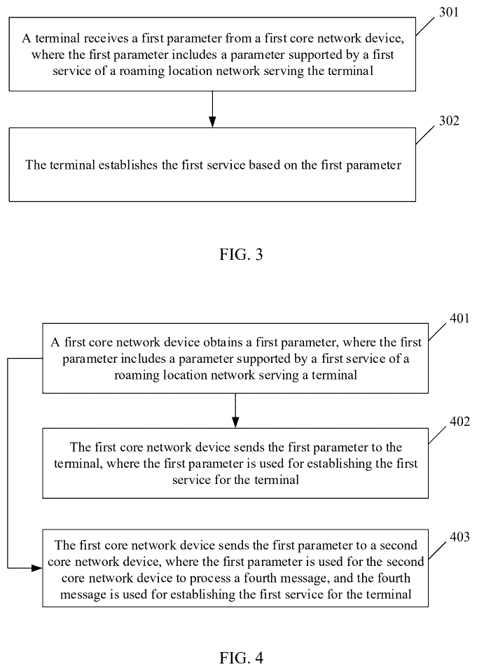

Referring to FIG. 4, an embodiment of this application provides a communication processing method applied to a first core network device, where the first core network device may include but is not limited to, an S-CSCF. The specific steps include: step 401, step 402, and step 403.

Step 401: The first core network device obtains a first parameter, where the first parameter includes a parameter supported by a first service of a roaming location network serving the terminal; and executes step 402 and/or step 403.

Step 402: The first core network device sends the first parameter to the terminal, where the first parameter is used for establishing the first service for the terminal.

Step 403: The first core network device sends the first parameter to a second core network device, where the first parameter is used for the second core network device to process a fourth message, and the fourth message is used for establishing the first service for the terminal.

For example, the fourth message may be a call request message sent by the terminal, or a call request message sent to the terminal. In other words, the second core network device can determine whether there is a need to process the call messages originated or terminated by the terminal based on the first parameter.

For example, the fourth message is an SIP Invite message.

For example, the call request message sent by the terminal can be understood as a call request message proactively initiated by the terminal; this call request message is routed through the P-CSCF serving the terminal to the S-CSCF serving the terminal and the AS serving the terminal.

The call request message sent to the terminal can be understood as a call request message sent to the terminal; this call request message is ultimately routed to the S-CSCF serving the terminal and the AS serving the terminal.

For example, the second core network device may be an application server, where the application server may include but is not limited to a telephony application server; or, the second core network device may be an S-CSCF.

In one embodiment of this application, that the first core network device obtains a first parameter may include:
the first core network device receives a register request message from the terminal; and
the first core network device obtains the first parameter in a case that the first core network determines, based on the register request message, that the terminal is in a roaming state.

For example, the register request message may be an SIP Register message.

In one embodiment of this application, that the first core network device sends the first parameter to the terminal may include:
the first core network device sends a register accept message to the terminal, where the register accept message may carry the first parameter.

In one embodiment of this application, that the first core network device obtains a first parameter includes:
the first core network device obtains the first parameter from a third core network device, where the third core network device may include but is not limited to a UDM, an HSS, or an Operation Administration and Maintenance (OAM).

In one embodiment of this application, that the first core network device obtains the first parameter from a third core network device includes:
the first core network device sends a fifth message to the third core network device, where the fifth message is used for requesting to obtain the first parameter; and
the first core network device receives a response message to the fifth message, where the response message carries the first parameter.

For example, the fifth message may be a subscription information request message.

In one embodiment of this application, that the first core network device obtains a first parameter may include:
the first core network device receives a register request message from the terminal, and in a case that the register request message contains the first parameter, the first core network device obtains the first parameter from the register request message.

For example, the first core network device receiving a register request message from the terminal may be understood as the first core network device receiving the register request message sent by the terminal.

In one embodiment of this application, that the first core network device obtains a first parameter includes:
the first core network device obtains the first parameter from a fourth core network device when the first core network device receives the register request message from the terminal; or
the first core network device obtains the first parameter from the fourth core network device when the first core network device receives a call request message, where the call request message is a call request message sent by the terminal or a call request message sent to the terminal; or
the first core network device receives the first parameter sent by the fourth core network device, where the fourth core network device sends the first parameter to the first core network device when the first parameter changes; where
the fourth core network device includes a policy control function PCF or a policy and charging rules function PCRF.

For example, after the first core network device receives the register request message from the terminal, the first core network device subscribes (Subscribe) to the fourth core network device for changes in the first parameter of the PLMN where the terminal is currently camping or registered. When the first parameter changes, the fourth core network device sends a notify message to the first core network device, where the notify message includes a parameter supported by the first service of the PLMN where the terminal is currently camping or registered, that is, the first parameter.

For example, the GBR parameter supported by the voice service of the 5G communication system of the PLMN where the terminal camps is 128 kbps, and the GBR parameter supported by the voice service of the 4G communication system is 64 kbps. When the terminal switches or reselects from 5G to 4G in this PLMN, the GBR supported by the voice service of the PLMN changes from 128 kbps to 64 kbps, that is, the first parameter changes from 128 kbps to 64 kbps. At this time, the fourth core network device will notify the first core network device. Here, the fourth core network device may be a Home Policy Control Function (H-PCF), and the first core network device may be the P-CSCF.

In one embodiment of this application, that the first core network device obtains a first parameter includes:
the first core network device receives a call request message, and in a case that the call request message contains the first parameter, the first core network device obtains the first parameter from the call request message, where the call request message is a call request message sent by the terminal or a call request message sent to the terminal; or
the first core network device receives a session initiation protocol message (SIP_Message), and in a case that the SIP_Message contains the first parameter, the first core network device obtains the first parameter from the SIP_Message. It should be noted that the SIP Message and SIP Invite are different messages; and the SIP Message is a message used for conveying information.

It should be noted that in this application, SIP_Message, SIP Invite, and SIP Register messages are each a type of SIP message. The SIP_Message message may also be referred to as an SIP_MESSAGE message, the SIP Invite message may also be referred to as an SIP INVITE message, and the SIP Register message may also be referred to as an SIP REGISTER message.

For example, when the first core network device receives the SIP_Message, the first core network device may be an S-CSCF, and the S-CSCF receives the SIP_Message sent by the P-CSCF. The P-CSCF sends the SIP_Message to the S-CSCF after receiving the first parameter sent by the fourth core network device.

For example, when the first core network device receives the register request message may be understood as before, after, or during the first core network device receiving the register request message.

For example, when the first core network device receives the call request message may be understood as before, after, or during the first core network device receiving the call request message.

In one embodiment of this application, the method that the first core network device sends the first parameter to the terminal includes:
the first core network device receives a call request message, where the call request message is a call request message sent by the terminal or a call request message sent to the terminal; and
the first core network device sends the first parameter to the terminal in a case that the first core network device determines that a parameter corresponding to the first service carried in the call request message does not match the first parameter.

For example, the call request message may be an SIP Invite message, where the SDP of the SIP Invite message carries the parameter corresponding to the first service.

Taking the first service being the voice service and the parameter being the GBR parameter as an example, the first core network device receives the description information in the SDP of the SIP Invite message as b=AS:512, that is, the GBR parameter value for the requested voice service is 512 kbps; when the first core network device determines that a value of the GBR parameter supported by the voice service supported by the PLMN currently serving the UE is 64 kbps, since 64 kbps is less than 512 kbps, the first core network device determines that the two parameters do not match and then sends 64 kbps to the terminal device.

In one embodiment of this application, that the first core network device sends the first parameter to the terminal includes:
the first core network device sends a 488 response message to the terminal device, where the 488 response message carries the first parameter.

In one embodiment of this application, that the first core network device sends the first parameter to a second core network device includes:
the first core network device sends a register request message to the second core network device, where the register request message may carry the first parameter.

In other words, during the IMS registration process of the terminal, the first core network device can send the obtained first parameter to the second core network device.

In one embodiment of this application, that the first core network device sends the first parameter to a second core network device includes:
the first core network device sends the fourth message to the second core network device, where the fourth message carries the first parameter.

In other words, when the terminal proactively initiates a call request message or receives a call request message, the first core network device may send the obtained first parameter to the second core network device.

In one embodiment of this application, the first parameter includes at least one of the following:
a value of guaranteed bit rate GBR; and
a value of maximum bit rate MBR.

In this application, the first parameter obtained by the first core network device from the third core network device or the fourth core network device may be a parameter supported by the first service of the 4G communication system of the roaming location network serving the terminal, a parameter supported by the first service of the 5G communication system of the roaming location network serving the terminal, or a smaller value of the two.

In the embodiments of this application, the first core network device may send the first parameter to the terminal and/or send the first parameter to the second core network device (for example, the application server or S-CSCF), allowing the terminal to establish the first service based on the obtained first parameter and/or allowing the second core network device to process the fourth message for establishing the first service for the terminal based on the first parameter, ensuring that the terminal and the communication counterpart can successfully establish the first service, thereby enhancing user experience.

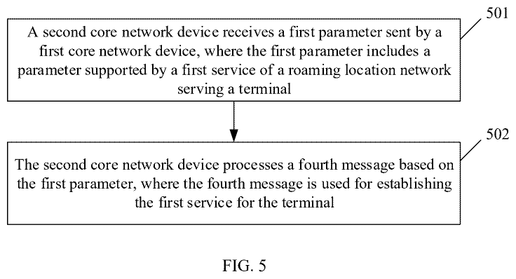

Referring to FIG. 5, an embodiment of this application provides a communication processing method applied to a second core network device, where the second core network device includes but is not limited to an application server, such as a telephony application server. Specific steps include: Step 501 and Step 502.

Step 501: The second core network device receives a first parameter sent by the first core network device, where the first parameter includes a parameter supported by the first service of a roaming location network serving the terminal.

Step 502: The second core network device processes a fourth message based on the first parameter, where the fourth message is used for establishing the first service for the terminal.

In one embodiment of this application, the fourth message is a call request message sent by the terminal or a call request message sent to the terminal. In other words, the second core network device can determine whether to process the call messages originated or terminated by the terminal based on the first parameter.

In one embodiment of this application, that the second core network device receives a first parameter sent by the first core network device includes:
the second core network device receives a register request message sent by the first core network device, where the register request message carries the first parameter.

For example, the second core network device stores the first parameter for use when the fourth message is received subsequently.

In one embodiment of this application, that the second core network device receives a first parameter sent by the first core network device includes:
the second core network device receives the fourth message sent by the first core network device, where the fourth message carries the first parameter.

In one embodiment of this application, that the second core network device receives a first parameter sent by the first core network device includes:
the second core network device receives an SIP_Message sent by the first core network device, where the SIP_Message carries the first parameter.

In one embodiment of this application, that the second core network device processes a fourth message based on the first parameter includes:
the second core network device determines whether the second parameter matches the first parameter, where the second parameter includes a parameter corresponding to the first service carried in the fourth message.

In a case that the second parameter does not match the first parameter, the second core network device modifies the second parameter such that the modified second parameter matches the first parameter.

For example, the communication counterpart of the terminal sends the modified fourth message.

For example, the parameter corresponding to the first service can be understood as the parameter of the first service. Taking the first service being the voice service and the parameter being the GBR parameter as an example, the parameter corresponding to the first service can be understood as a value of the GBR parameter.

Or,
in a case that the second parameter does not match the first parameter, the second core network device sends a sixth message, where the sixth message is used for rejecting the fourth message.

For example, the second core network device determines whether an absolute value of a difference between the second parameter and the first parameter is greater than a preset value. In a case that the absolute value of the difference between the second parameter and the first parameter is greater than or equal to the preset value, it is determined that they do not match; and in a case that the absolute value of the difference between the second parameter and the first parameter is less than the preset value, it is determined that they match.

In one embodiment of this application, the sixth message may also be referred to as a reject message, and the sixth message may carry the first parameter.

For example, the sixth message may be a 488 response message.

In the embodiments of this application, in a case that the second core network device obtains the fourth message for requesting to establish a call, the fourth message carries the first parameter, and the first parameter includes the parameter supported by the first service of the roaming location network serving the terminal, the second core network device can process the fourth message based on the first parameter, ensuring that the terminal and the communication counterpart can successfully establish the first service, thereby enhancing user experience. To facilitate understanding of the implementation of this application, the following describes Embodiment 1, Embodiment 2, Embodiment 3, Embodiment 4, Embodiment 5, Embodiment 6, and Embodiment 7.

### Embodiment 1

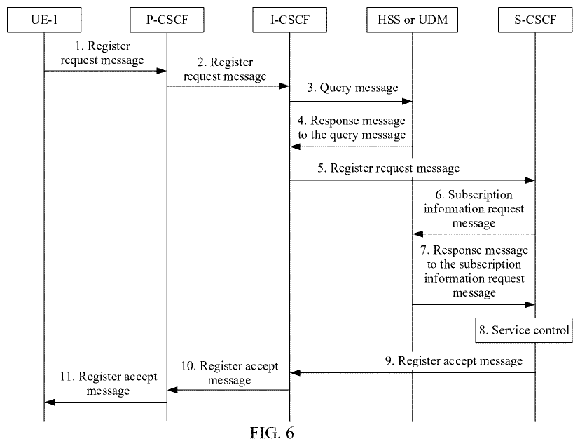

Referring to FIG. 6, the specific steps are as follows:

Step 1: UE-1 initiates a register request message, where the register request message contains an identity identifier and/or IP address information of UE-1.

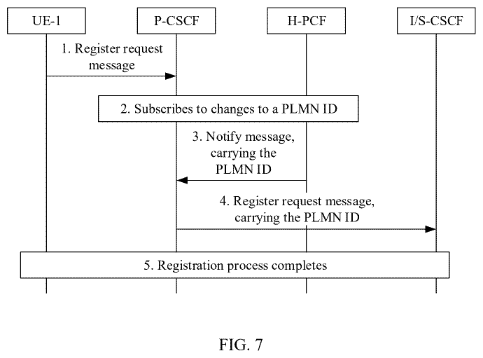

Step 2: A P-CSCF obtains an address of an Interrogating-Call Session Control Function (I-CSCF) and sends the register request message to the I-CSCF, where the register request message contains the information of a Public Land Mobile Network (PLMN) where UE-1 is currently registered. The method by which the P-CSCF obtains the PLMN information of UE-1 is shown in FIG. 7.

Steps 3 and 4: The I-CSCF sends a query message (for example, Cx-Query/Cx-Select-Pull) to an HSS or UDM, and the I-CSCF receives a response message (for example, Cx-Query Resp/Cx-Select-Pull Resp) from the HSS or UDM, where the response message carries an address of the S-CSCF.

In other words, the I-CSCF obtains the address of the S-CSCF by querying the HSS or UDM.

In the fourth generation (4G) mobile communication technology system, the I-CSCF sends a query message to the HSS. In the fifth generation (5G) mobile communication technology system, the I-CSCF sends a query message to the UDM.

Step 5: The I-CSCF sends the register request message to the S-CSCF.

Steps 6 and 7: The S-CSCF sends a subscription information request message (for example, Cx-put/Cx-Pull) to the HSS or UDM, and the HSS or UDM sends a response message (for example, Cx-put Resp/Cx-Pull Resp) to the S-CSCF, carrying the subscription information of UE-1.

In other words, the S-CSCF obtains the subscription information of UE-1 from the HSS or UDM, where the subscription information of UE-1 includes the GBR or MBR information supported by a voice service of a PLMN where the UE-1 is currently located (that is, VPLMN).

For example, the S-CSCF includes indication information for obtaining the GBR or MBR information supported by the voice service of the VPLMN in the subscription information request message in Step 6.

In another implementation, the S-CSCF may not obtain the GBR or MBR information from the HSS or UDM, and the S-CSCF obtains the GBR or MBR information supported by the voice service of the VPLMN from another network element, such as OAM.

Step 8: The S-CSCF performs service control, that is, the S-CSCF registers with an AS in the IMS network on behalf of UE-1.

For example, the application server may be a telephony application server (TAS).

Step 9: The S-CSCF sends a register accept message to UE-1, where the register accept message includes the GBR or MBR information available for the voice service of UE-1, that is, the GBR or MBR information supported by the voice service of the VPLMN that the S-CSCF obtained in Step 7.

Steps 10 and 11: UE-1 receives the register accept message.

Subsequently, when UE-1 negotiates the voice service with a communication counterpart (that is, UE-2), it uses the GBR or MBR information supported by the voice service of the VPLMN for negotiation.

Referring to FIG. 7, the specific steps include:

Step 1: UE-1 sends a register request message to a P-CSCF.

Step 2: The P-CSCF subscribes to a home policy control function (H-PCF) or a Policy and Charging Rules Function (PCRF) for changes to an ID of a PLMN currently serving UE-1.

For example, the P-CSCF further subscribes to GBR or MBR information supported by a voice service of the PLMN.

The GBR or MBR information may be a value of the GBR or MBR.

Step 3: The H-PCF sends a notify message to the P-CSCF, carrying the PLMN identity (ID).

For example, it further carries the GBR or MBR information supported by the voice service of the PLMN.

For example, if the GBR parameter supported by the voice service of the PLMN changes, for example, when the UE switches or reselects from the 5G communication system of the PLMN to the 4G communication system of the PLMN, the H-PCF will notify the P-CSCF.

The P-CSCF will further send the information to the S-CSCF via an SIP_Message message.

For example, the S-CSCF sends the information to the AS, and the information can be sent to the AS via an SIP_Message message.

For example, when the GBR parameter supported by the voice service of the 5G communication system of the PLMN is 128 kbps and the GBR parameter supported by the voice service of the 4G communication system is 64 kbps, when the terminal switches or reselects from the 5G communication system of the PLMN to the 4G communication system, the GBR supported by the voice service of the terminal changes from 128 kbps to 64 kbps. At this time, the H-PCF will notify the P-CSCF.

Step 4: The P-CSCF sends the register request message to the I/S-CSCF, carrying the PLMN ID.

For example, it further carries the GBR or MBR information supported by the voice service of the PLMN.

For example, the S-CSCF further sends the GBR or MBR information supported by the voice service of the PLMN to the AS.

Step 5: The registration process completes.

### Embodiment 2

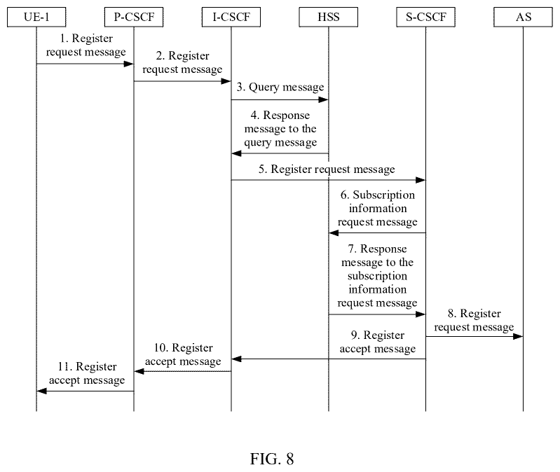

Referring to FIG. 8, the specific steps are as follows:

Steps 1 to 7: Refer to Steps 1 to 7 in FIG. 6.

Step 8: The S-CSCF sends the register request message to an AS, where the register request message may carry the GBR or MBR information supported by the voice service of the PLMN (that is, V-PLMN) where UE-1 is currently registered.

Steps 9 to 11: The S-CSCF sends a register accept message (for example, 200 ok message) to UE-1, where the register accept message may not include the GBR or MBR information.

For ease of description, the following explanation takes the first service being the voice service and the parameter being the GBR parameter as an example.

### Embodiment 3

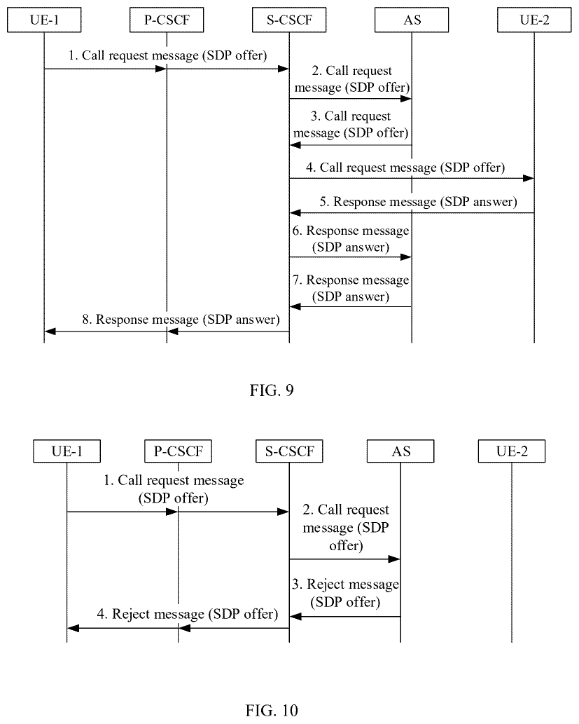

Referring to FIG. 9, the specific steps are as follows:

Step 1: UE-1 initiates a call request message to UE-2, where an SDP part of the request contains description information for requesting establishing voice communication, for example, requesting to establish a voice service with a GBR of 512 kbps via b=AS:512.

For example, the call request message may be an SIP Invite message.

Step 2: The S-CSCF sends the call request message to an AS serving UE-1.

Step 3: The AS modifies the GBR parameter in the call request message to a parameter supported by the voice service of a V-PLMN of UE-1 based on the obtained maximum GBR information of a PLMN where UE-1 is located, for example, modifying it to b=AS:64.

The maximum GBR information of the PLMN where UE-1 is located obtained by the AS can be obtained as described in Step 4 of FIG. 7 or Step 7 of FIG. 8, in other words, the information is obtained by receiving information sent by the S-CSCF in a registration process; or
the maximum GBR information of the PLMN where UE-1 is located is contained in the call request message in Step 2, and the AS obtains the maximum GBR information of the PLMN where UE-1 is located from the call request message. The GBR information is added to the call request message by the S-CSCF and sent to the AS.

For example, the maximum GBR information of the PLMN where UE-1 is located can be understood as a maximum value that the GBR parameter of the voice service of the PLMN where UE-1 is located can support.

For example, the PLMN where UE-1 is located can be understood as the PLMN where UE-1 is currently registered or camping.

For example, the AS determines that the GBR parameter in the call request message needs to be modified based on the obtained GBR information supported by the PLMN where UE-1 is located and a value of the GBR parameter carried in the call request message not matching.

Step 4: The S-CSCF sends the call request message to UE-2.

Steps 5 to 8: UE-2 sends a response message, carrying description information of the voice accepted by UE-2, and the response message may be a 200 OK message.

For example, after a voice call between UE-1 and UE-2 is successfully established, if UE-1 moves from the current PLMN to a new PLMN, according to the subscription in Step 2 of FIG. 7, the H-PCF sends a notify message to the P-CSCF, carrying the GBR parameter supported by the voice service of the new PLMN in the notify message; the P-CSCF further sends the GBR parameter supported by the voice service of the new PLMN to the S-CSCF; the S-CSCF sends it to the AS; the AS sends a re-invite message to UE-1 and/or UE-2 respectively, carrying the GBR parameter supported by the voice service of the new PLMN in the SDP of the re-Invite message, thereby modifying the GBR parameter of the voice call between UE-1 and UE-2 to the GBR parameter supported by the voice service of the new PLMN.

It can be understood that the above description uses UE-1 as the calling user as an example. UE-1 can also be the called user, that is, UE-2 initiates a call to UE-1, as shown in the figure. When the AS receives an SDP offer sent by UE-2, it can also modify the parameters.

### Embodiment 4

Referring to FIG. 10, the specific steps are as follows:

Step 1: UE-1 initiates a call request message to UE-2, where an SDP part of the request contains description information for requesting establishing voice communication, for example, requesting to establish a voice service with a GBR of 512 kbps via b=AS:512.

For example, the call request message may be an SIP Invite message.

Step 2: The S-CSCF sends the call request message to an AS serving UE-1.

For example, the S-CSCF adds the GBR information supported by the voice service of the PLMN where UE-1 is located, obtained in Step 4 of FIG. 7, to the SIP Invite message and sends it to the AS.

Step 3: The AS obtains maximum GBR information of the PLMN where UE-1 is located and includes the GBR parameter in a reject message (for example, a 488 response message).

The maximum GBR information of the PLMN where UE-1 is located obtained by the AS can be obtained as described in Step 4 of FIG. 7 or Step 7 of FIG. 8, in other words, the information is obtained by receiving information sent by the S-CSCF in a registration process; or
the maximum GBR information of the PLMN where UE-1 is located is contained in the call request message in Step 2, and the AS obtains the maximum GBR information of the PLMN where UE-1 is located from the call request message.

For example, the AS determines that it needs to send a 488 response message to UE-1 to reject the call request of UE-1 based on the obtained maximum GBR information of the PLMN where UE-1 is located not matching a value of the GBR parameter carried in the call request message.

Step 4: The S-CSCF sends the 488 response message to UE-1.

Subsequently, UE-1 uses the parameter contained in the 488 response message to re-initiate an invite message.

### Embodiment 5

Referring to FIG. 11, the specific steps are as follows:

Step 1: UE-1 initiates a call request message to UE-2, where an SDP part of the request contains description information for requesting establishing voice communication, for example, requesting to establish a voice service with a GBR of 512 kbps via b=AS:512.

Step 2: The S-CSCF obtains GBR information supported by the voice service of a PLMN (that is, V-PLMN) where UE-1 is currently registered, as described in Step 4 of FIG. 7, for example, the GBR is 64 kbps.

If a value of the GBR information is less than a value of the GBR carried by the UE in the call request message, for example, the GBR is 512 kbps, the S-CSCF sends a 488 response message to the UE, where the 488 response message contains the GBR parameter supported by the PLMN, for example, the GBR is 64 kbps.

Subsequently, UE-1 uses the parameter contained in the 488 response message to re-initiate a call request (invite) message.

### Embodiment 6

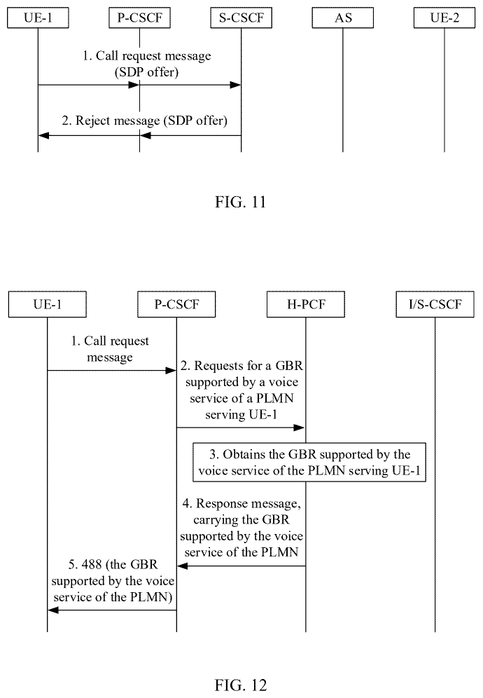

Referring to FIG. 12, the specific steps are as follows:

Step 1: UE-1 initiates a call request message to UE-2, where an SDP part of the request contains description information for requesting establishing voice communication, for example, requesting to establish the voice service with a GBR of 512 kbps via b=AS:512.

Step 2: After receiving the call request, the P-CSCF sends a request message to an H-PCF, requesting for the GBR parameter supported by the voice service of a PLMN where UE-1 is located.

Step 3: The H-PCF obtains the GBR parameter supported by the voice service of the VPLMN, for example, the GBR is 64 kbps.

For example, if the H-PCF has stored the parameter, the H-PCF obtains it locally; or, if the H-PCF has not stored the parameter, the H-PCF requests the parameter from an SMF serving UE-1.

Step 4: The H-PCF sends a response message to the P-CSCF, where the response message contains the GBR parameter supported by the voice service of the VPLMN, for example, the GBR is 64 kbps.

Step 5: If the P-CSCF determines that a value of the GBR information is less than a value of the GBR carried by the UE in an Invite message, the S-SCF sends a 488 response message to the UE, where the 488 response message contains the GBR parameter supported by the voice service of the VPLMN, for example, the GBR is 64 kbps.

For example, the description here uses UE-1 as the calling user as an example. UE-1 may also be the called user, that is, UE-2 initiates a call to UE-1 in the figure. In this case, after the P-CSCF receives the call request message from UE-2, the P-CSCF sends a 488 response message to UE-2.

### Embodiment 7

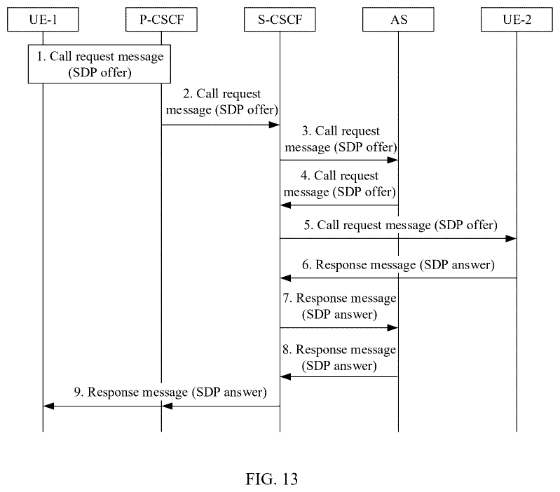

Referring to FIG. 13, the specific steps are as follows:

Step 1: Refer to Steps 1 to 4 in FIG. 12.

Step 2: The P-CSCF sends the call request message to an S-CSCF.

For example, the P-CSCF adds the GBR information supported by the voice service of the PLMN where UE-1 is located, obtained in Step 1, to an SIP Invite message and sends it to the S-CSCF.

Step 2: The S-CSCF sends the call request message to an AS serving UE-1.

Step 3: The AS modifies a GBR parameter in the call request message to the parameter supported by the voice service of the V-PLMN of UE-1 based on the obtained maximum GBR information of the PLMN where UE-1 is located, for example, modifying it to b=AS:64.

The AS obtaining the maximum GBR information of the PLMN where UE-1 is located may be as follows: the maximum GBR information of the PLMN where UE-1 is located is contained in the call request message in Step 2, and the AS obtains the maximum GBR information of the PLMN where UE-1 is located from the call request message. The GBR information is added to the call request message by the S-CSCF and sent to the AS.

For example, the AS determines that the GBR parameter in the call request message needs to be modified based on the obtained maximum GBR information of the PLMN where UE-1 is located and a value of the GBR parameter carried in the call request message not matching.

Steps 4 to 9: Refer to steps 3 to 8 in FIG. 12.

For example, “the maximum GBR information of the PLMN where UE-1 is located” mentioned in this application can be understood as the maximum value that the GBR parameter of the voice service of the PLMN where UE-1 is located can support.

For example, “the PLMN where UE-1 is located” mentioned in this application can be understood as the PLMN where UE-1 is currently registered or camping.

For example, the “maximum GBR information of the PLMN where UE-1 is located and a value of the GBR parameter carried in the call request message not matching” mentioned in this application can be understood as an absolute value of a difference between the maximum GBR value of the PLMN where UE-1 is located and a GBR parameter value carried in the call request message being greater than a preset value.

For example, the “second parameter does not match the first parameter” mentioned in this application can be understood as an absolute value of a difference between a value of the second parameter and a value of the first parameter being greater than a preset value.

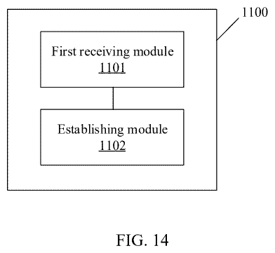

Referring to FIG. 14, an embodiment of this application provides a communication processing apparatus applied to a terminal, where the apparatus 1100 includes:
a first receiving module 1101, configured to receive a first parameter from a first core network device, where the first parameter includes a parameter supported by a first service of a roaming location network serving the terminal; and
an establishing module 1102, configured for the terminal to establish the first service based on the first parameter.

In one embodiment of this application, the apparatus further includes:
a first sending module, configured to send a register request message to the first core network device, where the register request message carries an identifier of the roaming location network serving the terminal.

In one embodiment of this application, the first receiving module 1101 is further configured to: receive a register accept message from the first core network device, where the register accept message carries the first parameter.

In one embodiment of this application, the establishing module 1102 is further configured to: send a first message, where the first message is used for requesting to establish the first service for the terminal, and the first message carries the first parameter; or send a second message, where the second message is used for responding to a third message, the third message is used for requesting to establish the first service for the terminal, and the second message carries the first parameter.

In one embodiment of this application, the parameter includes: at least one of GBR and MBR.

The apparatus provided in this embodiment of this application can implement the processes implemented in the method embodiments of FIG. 3, with the same technical effects achieved. To avoid repetition, details are not described herein again.

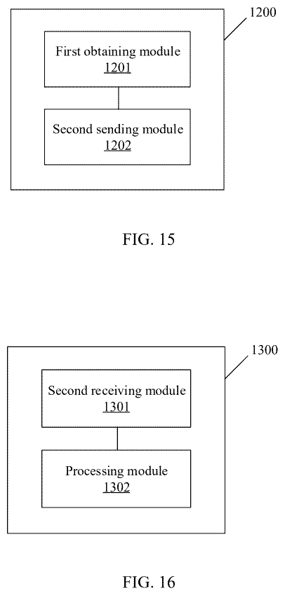

Referring to FIG. 15, an embodiment of this application provides a communication processing apparatus applied to a first core network device, where the apparatus 1200 includes:
a first obtaining module 1201, configured to obtain a first parameter, where the first parameter includes a parameter supported by a first service of a roaming location network serving the terminal; and
a second sending module 1202, configured to send the first parameter to the terminal, where the first parameter is used for establishing the first service for the terminal; and/or send the first parameter to a second core network device, where the first parameter is used for the second core network device to process a fourth message, and the fourth message is used for establishing the first service for the terminal.

In one embodiment of this application, the first obtaining module 1201 is further configured to: receive a register request message from the terminal; and obtain the first parameter in a case that the first core network determines, based on the register request message, that the terminal is in a roaming state.

In one embodiment of this application, the second sending module 1202 is further configured to: send a register accept message to the terminal, where the register accept message carries the first parameter.

In one embodiment of this application, the first obtaining module 1201 is further configured to: obtain the first parameter from a third core network device, where the third core network device includes a UDM, an HSS, or an OAM.

In one embodiment of this application, the first obtaining module 1201 is further configured to: send a fifth message to the third core network device, where the fifth message is used for requesting to obtain the first parameter; and receive a response message to the fifth message, where the response message carries the first parameter.

In one embodiment of this application, the second sending module 1202 is further configured to: send a register request message to the second core network device, where the register request message carries the first parameter.

In one embodiment of this application, the fourth message is a call request message sent by the terminal or a call request message sent to the terminal.

In one embodiment of this application, the first obtaining module 1201 is configured to, when receiving the register request message from the terminal, obtain the first parameter from the register request message when the register request message contains the first parameter; or, when receiving the register request message from the terminal, obtain the first parameter from the fourth core network device; or, when receiving the call request message, obtain the first parameter from the fourth core network device, where the call request message is a call request message sent by the terminal or a call request message sent to the terminal; or, receive the first parameter sent by the fourth core network device, where the fourth core network device sends the first parameter to the first core network device when the first parameter changes; and the fourth core network device includes a policy control function PCF or a policy and charging rules function PCRF.

In one embodiment of this application, the first obtaining module 1201 is configured to receive a call request message, and in a case that the call request message contains the first parameter, obtain the first parameter from the call request message, where the call request message is a call request message sent by the terminal or a call request message sent to the terminal; or, receive a session initiation protocol message SIP_Message, and in a case that the SIP_Message contains the first parameter, obtain the first parameter from the SIP_Message.

In one embodiment of this application, the second sending module 1202 is configured to receive a call request message, where the call request message is a call request message sent by the terminal or a call request message sent to the terminal; and the first core network device sends the first parameter to the terminal in a case that the first core network device determines that a parameter corresponding to the first service carried in the call request message does not match the first parameter.

In one embodiment of this application, the first core network device includes an S-CSCF.

The apparatus provided in this embodiment of this application can implement the processes implemented in the method embodiments of FIG. 4, with the same technical effects achieved. To avoid repetition, details are not described herein again.

Referring to FIG. 16, an embodiment of this application provides a communication processing apparatus applied to a second core network device, where the apparatus 1300 includes:
a second receiving module 1301, configured to receive a first parameter sent by a first core network device, where the first parameter includes a parameter supported by the first service of a roaming location network serving the terminal; and
a processing module 1302, configured to process a fourth message based on the first parameter, where the fourth message is used for establishing the first service for the terminal.

In one embodiment of this application, the fourth message is a call request message sent by the terminal or a call request message sent to the terminal.

In one embodiment of this application, the second receiving module 1301 is configured to receive a register request message sent by the first core network device, where the register request message carries the first parameter; receive the fourth message sent by the first core network device, where the fourth message carries the first parameter; or, receive the session initiation protocol message SIP_Message sent by the first core network device, where the SIP_Message carries the first parameter.

In one embodiment of this application, the processing module 1302 is further configured to:
determine whether the second parameter matches the first parameter, where the second parameter includes the parameter supported by the first service of the application server; and in a case that the second parameter does not match the first parameter, modify the second parameter so that the modified second parameter matches the first parameter; or, when the second core network device determines that the second parameter does not match the first parameter, the second core network device sends a sixth message, where the sixth message is used for rejecting the fourth message.

The second parameter includes a parameter corresponding to the first service carried in the fourth message.

In one embodiment of this application, the sixth message carries the first parameter or the serving call session control function S-CSCF.

In one embodiment of this application, the second core network device includes an application server.

The apparatus provided in this embodiment of this application can implement the processes implemented in the method embodiments of FIG. 5, with the same technical effects achieved. To avoid repetition, details are not described herein again.

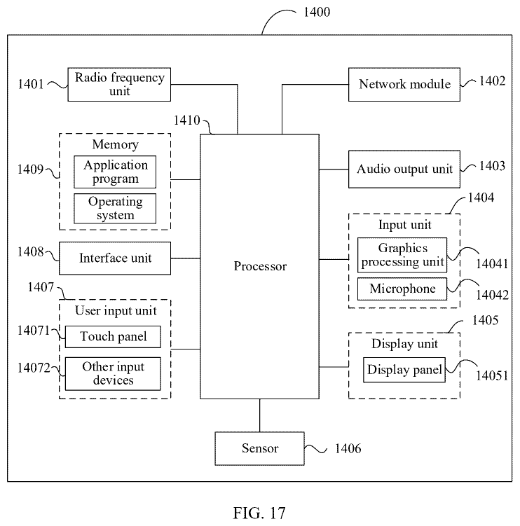

FIG. 17 is a schematic diagram of a hardware structure of a terminal implementing an embodiment of this application. The terminal 1400 includes but is not limited to at least part of these components: a radio frequency unit 1401, a network module 1402, an audio output unit 1403, an input unit 1404, a sensor 1405, a display unit 1406, a user input unit 1407, an interface unit 1408, a memory 1409, a processor 1410, and the like.

It can be understood by those skilled in the art that the terminal 1400 may further include a power supply (for example, battery) supplying power to the components. The power supply may be logically connected to the processor 1410 via a power management system, so that functions such as charge management, discharge management, and power consumption management are implemented via the power management system. The structure of the terminal shown in FIG. 17 does not constitute any limitation on the terminal, and the terminal may include more or fewer components than shown in the figure, or combine some of the components, or have different arrangements of the components. Details are not described herein.

It should be understood that in an embodiment of this application, the input unit 1404 may include a Graphics Processing Unit (GPU) 14041 and a microphone 14042. The graphics processing unit 14041 processes image data of a static picture or video obtained by an image capture apparatus (such as a camera) in an image capture or video capture mode. The display unit 1406 may include a display panel 14061. The display panel 14061 may be configured in a form of a liquid crystal display, an organic light-emitting diode display, or the like. The user input unit 1407 includes at least one of a touch panel 14071 and other input devices 14072. The touch panel 14071 is also referred to as a touchscreen. The touch panel 14071 may include two parts: a touch detection apparatus and a touch controller. The other input devices 14072 may include but are not limited to a physical keyboard, a function button (for example, volume control button or on/off button), a trackball, a mouse, and a joystick. Details are not described herein.

In an embodiment of this application, the radio frequency unit 1401 receives downlink data from a network-side device and transfers the data to the processor 1410 for processing; and the radio frequency unit 1401 can additionally send uplink data to the network-side device. Generally, the radio frequency unit 1401 includes but is not limited to an antenna, an amplifier, a transceiver, a coupler, a low noise amplifier, a duplexer, and the like.

The memory 1409 may be configured to store software programs or instructions and various data. The memory 1409 may include a first storage area for storing programs or instructions and a second storage area for storing data. The first storage area may store an operating system, an application program or instruction required by at least one function (for example, a sound play function or an image play function), and the like. Additionally, the memory 1409 may be a volatile memory or a non-volatile memory, or the memory 1409 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1409 in the embodiments of this application includes but is not be limited to these or any other applicable types of memories.

The processor 1410 may include one or more processing units. For example, the processor 1410 may integrate an application processor and a modem processor. The application processor primarily processes operations involving an operating system, user interface, application program, or the like. The modem processor primarily processes radio communication signals, for example, being a baseband processor. In some embodiments, it can be understood that the modem processor may be not integrated in the processor 1410.

The terminal provided by the embodiments of this application can realize the processes realized in the method embodiments of FIG. 3 with the same technical effects achieved. To avoid repetition, details are not described herein again.

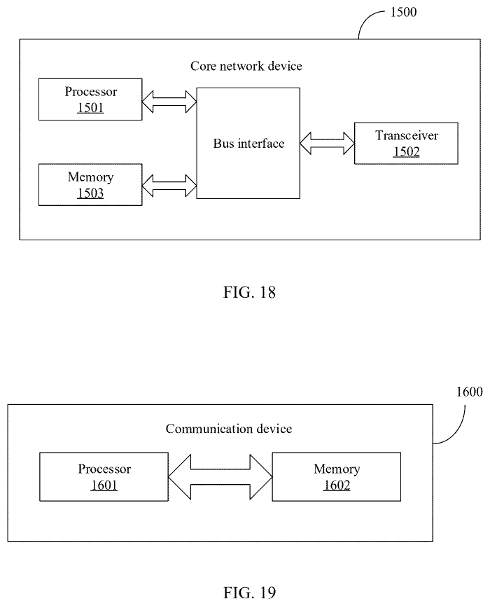

Referring to FIG. 18, FIG. 18 is a structural diagram of a core network device to which the embodiments of the present disclosure is applied. As shown in FIG. 18, the core network device 1500 includes a processor 1501, a transceiver 1502, a memory 1503, and a bus interface. The processor 1501 may be responsible for managing a bus architecture and general processing. The memory 1503 may store data that the processor 1501 uses when performing an operation.

In an embodiment of the present disclosure, the core network device 1500 further includes a program stored in the memory 1503 and capable of running on the processor 1501. When the program is executed by the processor 1501, the steps of the foregoing method shown in FIG. 4 or FIG. 5 are implemented.

In FIG. 18, a bus architecture may include any quantity of interconnected buses and bridges, for example, for interconnecting various circuits of one or more processors represented by the processor 1501 and a memory represented by the memory 1503. The bus architecture may further interconnect various other circuits such as a peripheral device, a voltage regulator, and a power management circuit. These are all well known in the art, and therefore are not further described in this specification. The bus interface provides an interface. The transceiver 1502 may be a plurality of components, that is, the transceiver 1502 includes a transmitter and a receiver, and provides a unit for communicating with various other apparatuses on a transmission medium.

For example, as shown in FIG. 19, an embodiment of this application further provides a communication device 1600 including a processor 1601 and a memory 1602. The memory 1602 stores a program or an instruction capable of running on the processor 1601. For example, in a case that the communication device 1600 is a terminal, when the program or the instruction is executed by the processor 1601, the steps of the foregoing method embodiments of FIG. 3 are implemented; and in a case that the communication device 1600 is a core network device, when the program or the instruction is executed by the processor 1601, the steps of the foregoing method embodiments of FIG. 4 or 5 are implemented, with the same technical effects achieved. To avoid repetition, details are not described herein again.

An embodiment of this application further provides a readable storage medium. The readable storage medium stores a program or an instruction, and when the program or instruction is executed by a processor, the processes of the method shown in FIG. 3, FIG. 4, or FIG. 5 and the foregoing method embodiments are implemented, with the same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or an instruction to implement the processes of method shown in FIG. 3, FIG. 4, or FIG. 5 and the foregoing method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and the computer program/program product is executed by at least one processor to implement the processes of the method shown in FIG. 3, FIG. 4, or FIG. 5 and the foregoing method embodiments, with the same technical effects achieved. To avoid repetition, details are not described herein again.

An embodiment of this application further provides a communication system. The communication system includes a terminal and a network-side device. The terminal is configured to perform the processes of FIG. 3 and the foregoing method embodiments, and the network-side device is configured to perform the processes of the method shown in FIG. 4 or FIG. 5 and the foregoing method embodiments, with the same technical effects achieved. To avoid repetition, details are not described herein again.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Based on the above description of embodiments, persons skilled in the art can clearly understand that the method in the foregoing embodiments can be implemented through software on a necessary hardware platform or through hardware only, but in many cases, the former is an example implementation. Based on such an understanding, the technical solutions of this application essentially or the part contributing to the prior art may be implemented in a form of a computer software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A communication processing method, comprising:
receiving, by a terminal, a first parameter from a first core network device, wherein the first parameter comprises a parameter supported by a first service of a roaming location network serving the terminal; and
establishing, by the terminal, the first service based on the first parameter.

2. The communication processing method according to claim 1, further comprising:
sending, by the terminal, a register request message to the first core network device, wherein the register request message carries an identifier of the roaming location network serving the terminal.

3. The communication processing method according to claim 2, wherein the receiving, by the terminal, the first parameter from the first core network device comprises:
receiving, by the terminal, a register accept message from the first core network device, wherein the register accept message carries the first parameter.

4. The communication processing method according to claim 1, wherein the establishing, by the terminal, the first service based on the first parameter comprises:
sending, by the terminal, a first message, wherein the first message is used for requesting to establish the first service for the terminal, and the first message carries the first parameter;
or,
sending, by the terminal, a second message, wherein the second message is used for responding to a third message, the third message is used for requesting to establish the first service for the terminal, and the second message carries the first parameter.

5. The communication processing method according to claim 1, wherein the parameter comprises at least one of Guaranteed Bit Rate (GBR) or Maximum Bit Rate (MBR).

6. The communication processing method according to claim 1, wherein the first core network device comprises a Serving Call Session Control Function (S-CSCF).

7. A communication processing method, comprising:
obtaining, by a first core network device, a first parameter, wherein the first parameter comprises a parameter supported by a first service of a roaming location network serving a terminal, and
sending, by the first core network device, the first parameter to the terminal, wherein the first parameter is used for establishing the first service for the terminal; or
sending, by the first core network device, the first parameter to a second core network device, wherein the first parameter is used for the second core network device to process a fourth message, and the fourth message is used for establishing the first service for the terminal.

8. The communication processing method according to claim 7, wherein the obtaining, by the first core network device, the first parameter comprises:
receiving, by the first core network device, a register request message from the terminal; and
obtaining, by the first core network device, the first parameter when the first core network determines, based on the register request message, that the terminal is in a roaming state.

9. The communication processing method according to claim 8, wherein the sending, by the first core network device, the first parameter to the terminal comprises:
sending, by the first core network device, a register accept message to the terminal, wherein the register accept message carries the first parameter.

10. The communication processing method according to claim 8, wherein the obtaining, by the first core network device, the first parameter comprises:
obtaining, by the first core network device, the first parameter from a third core network device, wherein the third core network device comprises a Unified Data Management (UDM), or a Home Subscriber Server (HSS), or an Operations, Administration, and Maintenance (OAM).

11. The communication processing method according to claim 10, wherein the obtaining, by the first core network device, the first parameter from a third core network device comprises:
sending, by the first core network device, a fifth message to the third core network device, wherein the fifth message is used for requesting to obtain the first parameter; and
receiving, by the first core network device, a response message to the fifth message, wherein the response message carries the first parameter.

12. The communication processing method according to claim 7, wherein the obtaining, by the first core network device, the first parameter comprises:
receiving, by the first core network device, a register request message from the terminal, and when the register request message contains the first parameter, obtaining, by the first core network device, the first parameter from the register request message; or
obtaining, by the first core network device, the first parameter from a fourth core network device when the first core network device receives the register request message from the terminal; or
obtaining, by the first core network device, the first parameter from the fourth core network device when the first core network device receives a call request message, wherein the call request message is a call request message sent by the terminal or a call request message sent to the terminal; or
receiving, by the first core network device, the first parameter sent by the fourth core network device, wherein the fourth core network device sends the first parameter to the first core network device when the first parameter changes, wherein
the fourth core network device comprises a Policy Control Function (PCF) or a Policy and Charging Rules Function (PCRF).

13. The communication processing method according to claim 7, wherein the obtaining, by the first core network device, the first parameter comprises:
receiving, by the first core network device, a call request message, and when the call request message contains the first parameter, obtaining, by the first core network device, the first parameter from the call request message, wherein the call request message is a call request message sent by the terminal or a call request message sent to the terminal; or
receiving, by the first core network device, a Session Initiation Protocol Message (SIP_Message), and when the SIP_Message contains the first parameter, obtaining, by the first core network device, the first parameter from the SIP_Message.

14. The communication processing method according to claim 7, wherein the sending, by the first core network device, the first parameter to the terminal comprises:
receiving, by the first core network device, a call request message, wherein the call request message is a call request message sent by the terminal or a call request message sent to the terminal; and
sending, by the first core network device, the first parameter to the terminal when the first core network device determines that a parameter corresponding to the first service carried in the call request message does not match the first parameter.

15. The communication processing method according to claim 14, wherein the sending, by the first core network device, the first parameter to the terminal comprises:
sending, by the first core network device, a 488 response message to the terminal, wherein the 488 response message carries the first parameter.

16. The communication processing method according to claim 7, wherein the sending, by the first core network device, the first parameter to the second core network device comprises:
sending, by the first core network device, a register request message to the second core network device, wherein the register request message carries the first parameter; or
sending, by the first core network device, the fourth message to the second core network device, wherein the fourth message carries the first parameter.

17. The communication processing method according to claim 7, wherein the fourth message is a call request message sent by the terminal or a call request message sent to the terminal.

18. The communication processing method according to claim 7, wherein the first parameter comprises at least one of the following:
a value of Guaranteed Bit Rate (GBR); or
a value of Maximum Bit Rate (MBR).

19. The communication processing method according to claim 7, wherein the first core network device comprises a Serving Call Session Control Function (S-CSCF) or a Proxy call Session Control Function (P-CSCF).

20. A communication device comprising a processor and a memory storing instructions, wherein the instructions, when executed by the processor, cause the processor to perform operations comprising:
receiving a first parameter from a first core network device, wherein the first parameter comprises a parameter supported by a first service of a roaming location network serving the communication device; and
establishing the first service based on the first parameter.
